(19) United States
(12) Patent Application Publication
(10) Pub. No.: US 2010/0185834 A1
(43) Pub. Date: Jul. 22, 2010

(54) Data Storing Method and Processor Using the Same

(75) Inventor: Sheng-Yuan Jan, Chiayi City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: Realtek Semiconductor Corp., HsinChu (TW)

(21) Appl. No.: 12/688,071

(22) Filed: Jan. 15, 2010

(30) Foreign Application Priority Data
Jan. 16, 2009 (TW) 98101681

(51) Int. Cl. G06F 9/30; G06F 9/38

(52) U.S. Cl. 712/205; 712/E09.016; 712/234; 712/E09.045

(57) ABSTRACT

A data storing method applied to a processor having a pipelined processing unit is provided. The pipelined processing unit includes stages. The stages include a source operand fetch stage and a write-back stage. The method includes the following steps. Firstly, a storing instruction is fetched and decoded. Next, the storing instruction is entered to the source operand fetch stage, and whether there is a late-done instruction in the pipelined processing unit is determined. The late-done instruction not lagged behind the storing instruction generates a late-coming result before entering the write-back stage. If it is determined that there is a late-done instruction in the pipelined processing unit, then the late-coming result is fetched before the storing instruction is entered to the write-back stage. Thereafter, the storing instruction is entered to the write-back stage, and the late-coming result is stored to a target memory which the storing instruction corresponds to.

This application claims the benefit of Taiwan application Serial No. 98101681, filed Jan. 16, 2009, the subject matter of which is incorporated herein by reference.

### BACKGROUND OF THE APPLICATION

1. Field of the Application

The application relates in general to a data storing method and a processor using the same, and more particularly to a data storing method a processor using the same for being applied to a processor having a pipelined processing unit and.

2. Description of the Related Art

Pipeling is a technology capable of parallelly executing instructions and increasing the hardware efficiency of a processor. That is, the pipelined processor does not decrease the required time for individual instruction. Instead, the pipelined processor increases instructions throughput. The throughput refers to the number of instructions that can be completed by a processor per unit time, i.e., it is determined by how often an instruction exits the pipeline.

However, there are situations, called hazards that decrease the execution efficiency of the pipelined processor. One of the commonly hazards relates to data hazard. For example, there is a situation in which a corresponding storage data of a storing instruction happens to be an execution result of a predetermined instruction, such as a load instruction, during a machine cycle of the pipeline. Under such as situation, data hazard will occur if the pipelined processor has not generated the execution result of predetermined instruction. At such, it is necessary to stall the pipeline for the storing instruction, thereby deteriorating the execution efficiency of the processor.

Therefore, it is a subject of the industrial endeavors to deal with the problem that a pipelined processor is required to stall for the storing instruction and thus increase the execution efficiency of the processor.

### SUMMARY OF THE APPLICATION

The application is directed to a data storing method and a processor using the same, which prevents the processor from being stalled for the storing instruction when data hazard occurs, thereby increasing the instruction throughput, reducing the execution time, and enhancing the execution efficiency of the processor.

According to a first aspect of the present application, a data storing method applied to a processor having a pipelined processing unit is provided. The pipelined processing unit includes a number of stages, which at least include a source operand fetch stage and a write-back stage. The method includes the following steps. Firstly, a storing instruction is fetched and decoded. Next, the storing instruction is allowed to enter the source operand fetch stage, and whether there is a late-done instruction in the pipelined processing unit is determined. The late-done instruction is not lagged behind the storing instruction, and generates a late-coming result before entering the write-back stage. If it is determined that there is a late-done instruction in the pipelined processing unit, then the late-coming result is fetched before the storing instruction enters the write-back stage. Thereafter, the storing instruction is allowed to enter the write-back stage, and the late-coming result is stored in a target memory which the storing instruction corresponds to.

According to a second aspect of the present application, a processor including a pipelined processing unit and a first register is provided. The pipelined processing unit includes a number of stages, which at least include a source operand fetch stage and a write-back stage. The pipelined processing unit is used for fetching and decoding a storing instruction. The pipelined processing unit allows the storing instruction to enter at least the source operand fetch stage and the write-back stage sequentially. The pipelined processing unit is further used for determining whether there is a late-done instruction in the pipelined processing unit is determined. The late-done instruction is not lagged behind the storing instruction, and generates a late-coming result before entering the write-back stage. The first register, disposed before the write-back stage, is used for storing the late-coming result. If the pipelined processing unit determines that there is a late-done instruction in the pipelined processing unit, then the pipelined processing unit is further used for fetching the late-coming result before the storing instruction enters the write-back stage. The pipelined processing unit is further used for storing the late-coming result in a corresponding target memory of the storing instruction when the storing instruction enters the write-back stage.

The application will become apparent from the following detailed description of the preferred but non-limiting embodiments. The following description is made with reference to the accompanying drawings.

### BRIEF DESCRIPTION OF THE DRAWINGS

FIG. 1 shows a flowchart of a data storing method according to an embodiment of the application;

FIG. 2 shows detailed procedures of the data storing method according to an embodiment of the application;

FIG. 3 shows an example of a pipelined processing unit of a processor using the data storing method of the application and the processing order of the instructions;

FIG. 4 shows another example of a pipelined processing unit of a processor using the data storing method of the application and the processing order of the instructions; and

FIG. 5 shows a block diagram of a processor using the data storing method of the application.

### DETAILED DESCRIPTION OF THE APPLICATION

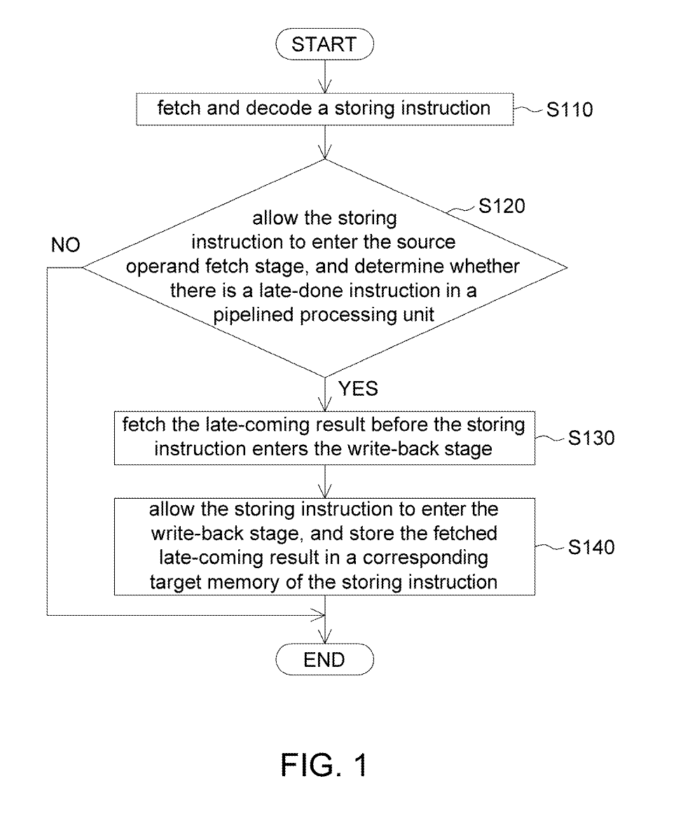

Referring to FIG. 1, a flowchart of a data storing method according to an embodiment of the application is shown. The data storing method is applied to a processor having a pipelined processing unit. The pipelined processing unit includes a number of stages, and the stages include a source operand fetch stage and a write-back stage. The method includes the following steps.

Firstly, the method begins at step S110, a storing instruction is fetched, and the storing instruction is decoded.

Next, the method proceeds to step S120, the storing instruction is allowed to enter the source operand fetch stage, and whether there is a late-done instruction in the pipelined processing unit is determined. The late-done instruction is not lagged behind the storing instruction, and generates a late-coming result before entering the write-back stage.

If it is determined that there is a late-done instruction in the pipelined processing unit, then the method proceeds to step S130, in which the late-coming result is fetched before the storing instruction enters the write-back stage. Next, the method proceeds to step S140, the storing instruction is allowed to enter the write-back stage, and the late-coming result is stored in a corresponding target memory of the storing instruction.

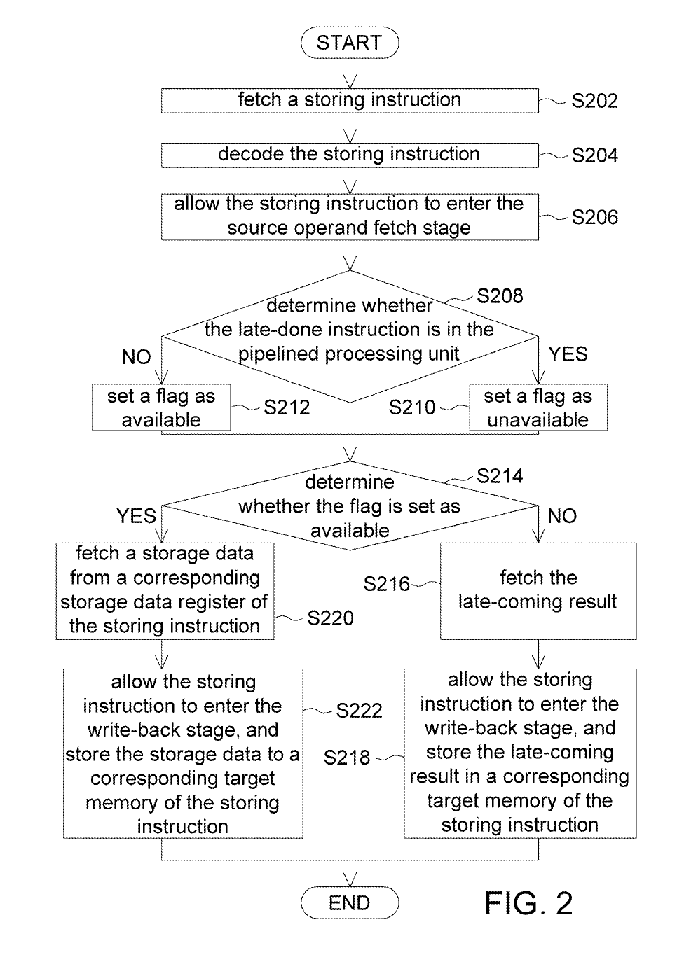

The detailed procedures of the data storing method of FIG. 1 are disclosed below. Referring to FIG. 2, detailed procedures of the data storing method according to an embodiment of the application are shown.

Firstly, the method begins at step S202, a storing instruction is fetched. Next, the method proceeds to step S204, the storing instruction is decoded. After the storing instruction is decoded, the obtained results include the index value of a storage data register which the storing instruction corresponds to and the index value of a register used for storing the address of a target memory.

Thereafter, the method proceeds to step S206, the storing instruction is allowed to enter the source operand fetch stage. Next, the method proceeds to step S208, whether there is a late-done instruction in the pipelined processing unit is determined.

In an embodiment, when determining whether there is a late-done instruction in the pipelined processing unit, the step S208 may further include the following detailed procedures. Firstly, it is determined that whether the index value of the storage data register which the storing instruction corresponds to is the same with the index value of a target register which the late-done instruction corresponds to, wherein the target register is used for storing the late-coming result. Then, it is determined that whether the late-done instruction has not generated the late-coming result when the storing instruction enters the source operand fetch stage. Thereafter, it is determined that whether the late-done instruction has generated the late-coming result before the storing instruction enters the write-back stage. In an embodiment, the generated late-coming result is stored to a register. In another embodiment, the generated late-coming result is directly passed to the storing instruction.

If there is a late-done instruction in the pipelined processing unit, then the method proceeds to step S210, a flag is set as unavailable. If there is no late-done instruction in the pipelined processing unit, then the method proceeds to step S212, the flag is set as available.

Next, before the storing instruction is in the write-back stage, the method proceeds to step S214, whether the flag is set as available is determined.

If the flag and is not set as available, then the method proceeds to step S216, a late-coming result is fetched. Thereafter, the method proceeds to step S218, the storing instruction is allowed to enter the write-back stage, and the late-coming result is stored in the target memory which the storing instruction corresponds to.

If the flag is set as available, then the method proceeds to step S220, a storage data is fetched from the storage data register which the storing instruction corresponds to. Thereafter, the method proceeds to step S222, the storing instruction is allowed to enter the write-back stage, the storage data is stored in the target memory which the storing instruction corresponds to, and the method terminates.

The data storing method of the application can be applied to a processor having a pipelined processing unit. The late-done instruction can be any instruction. In an embodiment, the late-done instruction can be, for example, a load instruction or an arithmetic logic unit instruction. The late-done instruction of the application is exemplified by two examples below.

### First Example

In the first example, the late-done instruction is a load instruction LW, and the late-coming result generated from the late-done instruction is the load data generated from the load instruction LW.

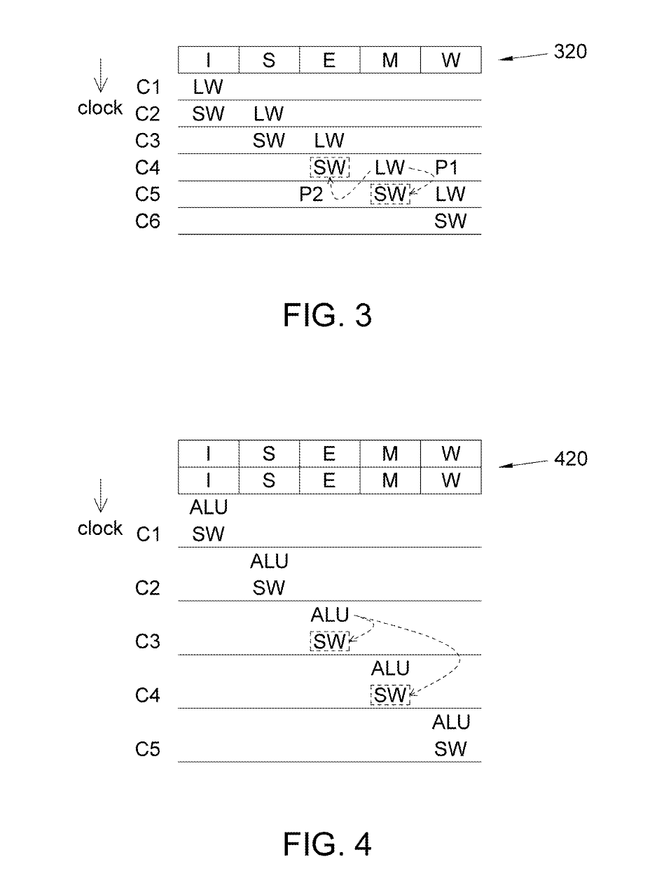

Referring to FIG. 3, an example is shown for a pipelined processing unit of a processor using the data storing method of the application and the progress of the instructions with respect to a clock. The pipelined processing unit 320 includes an instruction fetch stage I, a source operand fetch stage S, an execution stage E, a memory access stage M, and a write-back stage W.

In FIG. 3, the direction of “clock” indicates time order, and the duration in each of processing periods C1˜C6 is a machine cycle. In other words, the processing period at each stage of the pipelined processing unit 320 is a machine cycle.

In the present example, the load instruction LW and the storing instruction SW are sequentially fetched by the pipelined processing unit 320 at the instruction fetch stage I. The fetched load instruction LW and the storing instruction SW are respectively expressed as follows for illustration without any intend of limitation:

“lw $1,0($2)”

“sw $1,0($3)”

The load instruction LW (“lw $1, 0 ($2)”) is used for loading a load data, which is stored in the target memory whose address is [$2], to a target register whose index value is $1; the storing instruction SW (“sw $1, 0 ($3)”) is used for storing data of a storage data register whose index value is $1 in the target memory whose address is [$3].

According to the detailed procedures of step S208, the pipelined processing unit 320 determines that the index value ($1) of the storage data register which the storing instruction SW corresponds to is the same with the index value ($1) of the target register which the load instruction LW corresponds to.

As indicated in FIG. 3, the load data is generated when the load instruction LW enters the memory access stage M, such as the progress in the processing period C4. Thus, the pipelined processing unit 320 determines that the load instruction LW has not generated the load data when the storing instruction SW enters the source operand fetch stage S, such as the progress in the processing period C3. The pipelined processing unit 320 further determines that the load instruction LW has already generated the load data before the storing instruction SW enters the write-back stage W, such as the progress before the processing period C6.

Thus, in the first example, the pipelined processing unit 320 regards the abovementioned load instruction LW as a late-done instruction, and determines that there is a late-done instruction in the pipelined processing unit 320.

### Second Example

In the second example, the late-done instruction is an arithmetic logic unit instruction ALU, and the late-coming result generated from the late-done instruction is a computation result generated from the arithmetic logic unit instruction ALU.

Referring to FIG. 4, another example is shown for a pipelined processing unit 420 of a processor using the data storing method of the application and the progress of the instructions with respect to a clock. In the present example, the processor, capable of performing two instructions parallelly, is a two way superscalar micro-processor for example. The pipelined processing unit 420 includes two instructions fetch stage I, two source operand fetch stages S, two execution stages E, two memory access stages M, and two write-back stages W which are respectively disposed in parallel.

In the present, the arithmetic logic unit instruction ALU and the storing instruction LW are parallelly fetched by the pipelined processing unit 420 at the instruction fetch stage I. The arithmetic logic unit instruction ALU and the storing instruction LW are respectively expressed as follows for illustration with any intend of limitation:

“add $1,$1,1”

“sw $1,0($3)”

The arithmetic logic unit instruction ALU (“add $1, $1, 1”) is used for adding the stored value of the register whose index value is $1 by 1, and storing the computation result in a target register whose index value $1; the storing instruction (“sw $1, 0 ($3)”) is used for storing the data of a storage data register whose index value is $1 to the target memory whose address is [$3].

What is similar to the first example is as follows. The pipelined processing unit 420 determines that the index value ($1) of the storage data register which the storing instruction SW corresponds to is the same with the index value ($1) of the target register which the arithmetic logic unit instruction ALU corresponds to.

As indicated in FIG. 4, the computation result is generated when the arithmetic logic unit instruction ALU enters the execution stage E, such as the progress in the processing period C3. Thus, the pipelined processing unit 420 determines that the arithmetic logic unit instruction ALU has not generated the computation result when the storing instruction SW enters the source operand fetch stage S, such as the progress in the processing period C2. The pipelined processing unit 420 further determines that the arithmetic logic unit instruction ALU has already generated the computation result before the storing instruction SW enters the write-back stage W, such as the progress before the processing period C5.

Thus, in the second example, the pipelined processing unit 420 regards the abovementioned arithmetic logic unit instruction ALU as a late-done instruction, and determines that there is a late-done instruction in the pipelined processing unit 420.

In the above two examples, when it is determined that there is a late-done instruction, such as a load instruction LW or an arithmetic logic unit instruction ALU for example, in the pipelined processing unit, late-coming result, such as the load data or the computation result, is optionally stored in a register 540 (not illustrated in FIGS. 3 and 4) or is passed directly to the storing instruction SW. Then, before the storing instruction SW is at the write-back stage W, e.g., when the storing instruction SW is at the memory access stage M or at the execution stage E (illustrated with the dotted lines in FIG. 3 and FIG. 4), a late-coming result is fetched. In one example, when the load instruction LW is at the memory access stage M in the processing period C4, the late-coming result is stored in the register 540. After that, when the storing instruction SW is at the memory access stage M in the processing period C5, the late-coming result is fetched from the register 540, as shown by dotted line P1 in FIG. 3. In another example, when the load instruction LW is at the memory access stage M in the processing period C4 and the storing instruction SW is at the execution stage E in the same processing period C4, the late-coming result generated by the load instruction LW is passed directly to the storing instruction SW, as shown by dotted line P2 in FIG. 3. Thereafter, when the storing instruction SW enters the write-back stage W, the late-coming result is stored in the corresponding target memory of the storing instruction SW.

As indicated in FIGS. 3 and 4, although there is data hazard when the storing instruction SW enters the source operand fetch stage S, which means that the processor is now allowed to obtain the late-coming result generated from the late-coming instruction at this stage, the processor can be operated without being stalled for the storing instruction SW. Additionally, the operation of the storing instruction SW can be completed as long as the late-coming result is received before the storing instruction SW is at the write-back stage W.

Thus, the present embodiment prevents the processor from being stalled for the storing instruction when data hazard occurs, thereby increasing the throughput of the instruction of the processor, reducing the execution time of the processor, and increasing the execution efficiency of the processor.

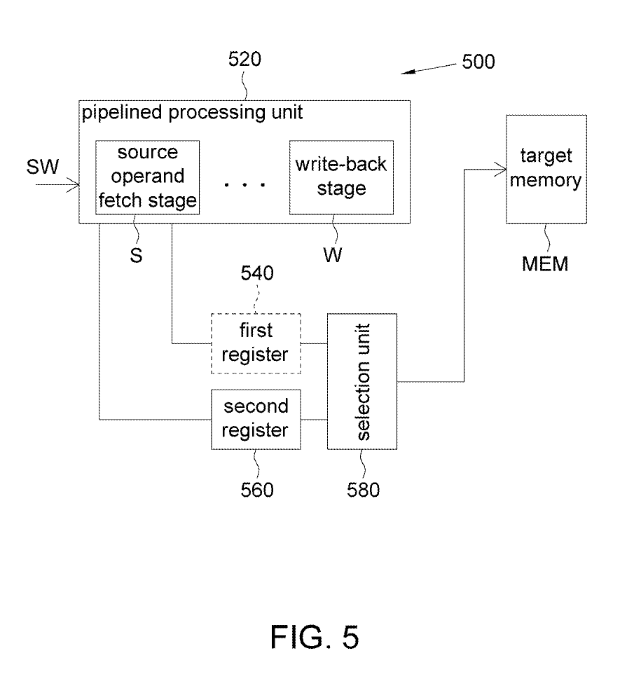

Besides, the application further provides a processor using the data storing method disclosed above. Referring to FIG. 5, a block diagram of a processor 500 using the data storing method of the application is shown.

The processor 500 includes a pipelined processing unit 520, a first register 540, a second register 560, and a selection unit 580. In an embodiment, the processor 500 can be a processor capable of sequentially processing instructions, or a processor capable of processing at least two instructions parallelly. For example, the pipelined processing unit 520 of the processor 500 can be implemented by the pipelined processing unit 320 of FIG. 3 which is capable of sequentially processing instructions. Optionally, the pipelined processing unit 520 of the processor 500 can be implemented by the pipelined processing unit 420 of FIG. 4 which is capable of performing at least two instructions parallelly. Alternately, the pipelined processing unit 520 of the processor 500 can also be implemented by a pipelined processing unit capable of processing several instructions parallelly.

The pipelined processing unit 520 includes a number of stages which at least include a source operand fetch stage S and a write-back stage W. The pipelined processing unit 520 is used for fetching a storing instruction SW, and for decoding the storing instruction SW. The pipelined processing unit 520 allows the storing instruction SW to enter at least the source operand fetch stage S and the write-back stage W sequentially.

The pipelined processing unit 520 is further used for determining whether there is a late-done instruction in the pipelined processing unit 520. The late-done instruction is not lagged behind the storing instruction SW, and generates a late-coming result before the late-done instruction enters the write-back stage W. The late-done instruction is, for example, the load instruction LW or the arithmetic logic unit instruction ALU mentioned in the above two examples.

The first register 540 is disposed before the write-back stage W. Similarly, the second register 560 and the selection unit 580 can also be disposed before the write-back stage W.

Illustration is made below for demonstrating the disposition of the two registers 540, 560 and the selection unit 580. In an embodiment, the stages of the pipelined processing unit 520 may further include at least one pipeline processing stage disposed between the source operand fetch stage S and the write-back stage W.

For example, the stages of the pipelined processing unit 520 may further include the memory access stage M and the execution stage E of FIG. 3 or FIG. 4. The late-coming result is generated when there is a late-done instruction in the memory access stage M. The address of the corresponding target memory MEM is generated when the storing instruction SW is at the execution stage E.

As the memory access stage M and the execution stage E are both disposed before the write-back stage W, the first register 540 can be disposed in the memory access stage M or the execution stage E. Similarly, the second register 560 and the selection unit 580 can also be disposed in the memory access stage M or the execution stage E. In an embodiment, the two registers 540, 560 and the selection unit 580 are disposed in the same stage, and the late-coming storing instruction generates a late-coming result when entering this stage.

The first register 540 is used for storing the late-coming result optionally, which is the one generated from the late-done instruction and stored by the pipelined processing unit 520. The first register 540 can be omitted in some embodiments. The second register 560 is used for storing a storage data, which is fetched by the pipelined processing unit 520 from the storage data register which the storing instruction SW corresponds to. The selection unit 580 is coupled to the two registers 540 and 560 for providing one of the late-coming result and the storage data under the control of the pipelined processing unit 520.

If there is a late-done instruction in the pipelined processing unit 520, the pipelined processing unit 520 is further used for setting a flag as unavailable when the storing instruction SW is at the source operand fetch stage S. To the contrary, if there is no late-done instruction in the pipelined processing unit 520, then the pipelined processing unit 520 sets the flag as available, fetches a storage data from the storage data register which the storing instruction SW corresponds to, and stores the fetched data in the second register 560.

Then, if the flag is set as unavailable, then the pipelined processing unit 520 is further used for fetching a late-coming result from the first register 540 before the storing instruction SW enters the write-back stage W. For example, the pipelined processing unit 520 may control the selection unit 580 to fetch a late-coming result from the first register 540. Next, the pipelined processing unit 520 stores the late-coming result in the target memory MEM which the storing instruction SW corresponds to when the storing instruction SW enters the write-back stage W.

Correspondingly, if the flag is set as available, the pipelined processing unit 520 is further used for controlling the selection unit 580 to fetch a storage data from the second register 560 before the storing instruction SW enters the write-back stage W. Then, the pipelined processing unit 520 stores the storage data to the target memory MEM which the storing instruction SW corresponds to when the storing instruction SW is at the write-back stage W.

The above embodiments of the application are exemplified by the processor having five-stage pipeline processing unit as indicated in FIG. 3 or FIG. 4. However, the exemplification is provided for elaborating the application without any intends of limitation. The data storing method and the processor using the same disclosed in the application can also be applied to other types of pipeline processing units.

According to the data storing method and the processor using the same disclosed in the above embodiments of the application, the processor can be prevented from being stalled for the storing instruction when data hazard occurs, thereby increasing the throughput of the instruction, reducing the execution time, and increasing the execution efficiency of the processor.

While the application has been described by way of example and in terms of a preferred embodiment, it is to be understood that the application is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A data storing method applied to a processor having a pipelined processing unit, wherein the pipelined processing unit comprises a plurality of stages, the stages at least include a source operand fetch stage and a write-back stage, and the method comprises the steps of:
fetching a storing instruction and decoding the storing instruction;
allowing the storing instruction to enter the source operand fetch stage, and determining whether there is a late-done instruction in the pipelined processing unit, the late-done instruction being not lagged behind the storing instruction, the late-done instruction generating a late-coming result before entering the write-back stage;
fetching the late-coming result before the storing instruction enters the write-back stage if it is determined that there is a late-done instruction in the pipelined processing unit; and
allowing the storing instruction to enter the write-back stage, and storing the fetched late-coming result in a corresponding target memory of the storing instruction.

2. The data storing method according to claim 1, wherein the step of determining whether there is a late-done instruction in the pipelined processing unit comprises:
determining whether the index value of a corresponding storage data register of the storing instruction is the same with the index value of a corresponding target register of the late-done instruction, wherein the target register is for storing the late-coming result;
determining whether the late-done instruction has not generated the late-coming result when the storing instruction enters the source operand fetch stage; and
determining whether the late-done instruction has generated the late-coming result before the storing instruction enters the write-back stage.

3. The data storing method according to claim 1, wherein before the step of fetching the late-coming result, the method further comprises the steps of:
setting a flag as unavailable if there is a late-done instruction in the pipelined processing unit when the storing instruction is at the source operand fetch stage; and
executing the step of fetching the late-coming result before the storing instruction enters the write-back stage if the flag is set as unavailable.

4. The data storing method according to claim 1, further comprising the steps of:
setting a flag as available and fetching a storage data from a corresponding storage data register of the storing instruction if there is no late-done instruction in the pipelined processing unit when the storing instruction is at the source operand fetch stage; and
storing the storage data in the corresponding target memory of the storing instruction when the storing instruction is at the write-back stage and terminating the method if the flag is set as available.

5. The data storing method according to claim 4, further comprising:
storing the storage data fetched from the storage data register to a second register when the storing instruction is at the source operand fetch stage.

6. The data storing method according to claim 1, further comprising:
storing the late-coming result to a first register when the late-done instruction generates the late-coming result.

7. The data storing method according to claim 6, wherein the stages further comprise a memory access stage disposed before the write-back stage, and the first register is disposed in the memory access stage;
wherein the late-done instruction generates the late-coming result when being at the memory access stage.

8. The data storing method according to claim 6, wherein the stages further comprises a memory access stage disposed before the write-back stage and an execution stage disposed before the memory access stage, and the first register is disposed in the execution stage;
wherein the storing instruction generates an address of the corresponding target memory when the storing instruction is at the execution stage, and the late-done instruction generates the late-coming result when the late-done instruction is in the execution stage.

9. The data storing method according to claim 1, wherein the late-done instruction is a load instruction or an arithmetic logic unit (ALU) instruction.

10. The data storing method according to claim 1, wherein the processor is capable of executing at least two instructions parallelly.

11. The data storing method according to claim 1, wherein the stages further comprises at least one pipeline processing stage disposed between the source operand fetch stage and the write-back stage.

12. A processor, comprising:
a pipelined processing unit comprising a plurality of stages, wherein the stages at least comprise a source operand fetch stage and a write-back stage, the pipelined processing unit is used for fetching a storing instruction and decoding the storing instruction, the pipelined processing unit allows the storing instruction to enter at least the source operand fetch stage and the write-back stage sequentially, the pipelined processing unit is further used for determining whether there is a late-done instruction in the pipelined processing unit, the late-done instruction is not lagged behind the storing instruction, and the late-done instruction generates a late-coming result before entering the write-back stage; and
a first register disposed before the write-back stage for storing the late-coming result;
wherein the pipelined processing unit is further used for fetching the late-coming result from the first register before the storing instruction enters the write-back stage if the pipelined processing unit determines that there is a late-done instruction in the pipelined processing unit;
wherein the pipelined processing unit is used for storing the fetched late-coming result to a corresponding target memory of the storing instruction when the storing instruction enters the write-back stage.

13. The processor according to claim 12, wherein when the pipelined processing unit determines whether there is a late-done instruction in the pipelined processing unit, the pipelined processing unit determines whether the index value of a corresponding storage data register of the storing instruction is the same with the index value of a corresponding target register of the late-done instruction,
wherein the target register is used for storing the late-coming result, the pipelined processing unit also determines whether the late-done instruction has not generated the late-coming result when the storing instruction enters the source operand fetch stage, and the pipelined processing unit also determines whether the late-done instruction has generated the late-coming result before the storing instruction enters the write-back stage.

14. The processor according to claim 12, wherein the pipelined processing unit is further used for
setting a flag as unavailable if there is a late-done instruction in the pipelined processing unit when the storing instruction is at the source operand fetch stage; and
fetching the late-coming result before the storing instruction enters the write-back stage if the flag is set as unavailable.

15. The processor according to claim 12, wherein the pipelined processing unit is further used for
setting a flag as available and fetching a storage data from a corresponding storage data register of the storing instruction if there is no late-done instruction in the pipelined processing unit when the storing instruction is at the source operand fetch stage; and
storing the storage data in the corresponding target memory of the storing instruction when the storing instruction is at the source operand fetch stage if the flag is set as available, but no longer storing the late-coming result to the target memory when the storing instruction is at the write-back stage.

16. The processor according to claim 15, further comprising:
a second register disposed before the write-back stage for storing the storage data fetched from the storage data register by the pipelined processing unit.

17. The processor according to claim 16, further comprising:
a selection unit disposed before the write-back stage and coupled to the first and the second registers for providing one of the late-coming result and the storage data under the control of the pipelined processing unit.

18. The processor according to claim 12, wherein when the late-done instruction generates the late-coming result, the pipelined processing unit stores the late-coming result in the first register.

19. The processor according to claim 18, wherein the stages further comprise:
a memory access stage disposed before the write-back stage, wherein the late-coming result is generated when there is a late-done instruction in the memory access stage;
wherein the first register is disposed in the memory access stage.

20. The processor according to claim 18, wherein the stages further comprise:
a memory access stage disposed before the write-back stage; and
an execution stage disposed before the write-back stage, wherein an address of the corresponding target memory is generated when the storing instruction is at the execution stage, and the late-coming result is generated when there is a late-done instruction in the execution stage;
wherein the first register is disposed in the execution stage.

21. The processor according to claim 12, wherein the late-done instruction is a load instruction or an arithmetic logic unit (ALU) instruction.

22. The processor according to claim 12, the processor is capable of executing at least two instructions parallelly.

23. The processor according to claim 12, wherein the stages further comprise at least a pipeline processing stage disposed between the source operand fetch stage and the write-back stage.
